(19) United States
(12) Patent Application Publication
(10) Pub. No.: US 2005/0100169 A1
(43) Pub. Date: May 12, 2005

(54) Automotive gauge-based sound pressure instrument

(76) Inventors: Kenneth Shelley, Lake Worth, FL (US); William Anderson, Lake Worth, FL (US)

Correspondence Address: Michael A. Slavin, Esq.;McHale & Slavin, P.A., 2855 PGA Boulevard, Palm Beach Gardens, FL, 33410, US

(21) Appl. No.: 10/705,349

(22) Filed: Nov. 10, 2003

(51) Int. Cl. H04R 29/00; H04B 1/00

(52) U.S. Cl. 381/58; 381/86

(57) ABSTRACT

The instant invention provides a novel and useful gauge-based sound pressure instrument that is mountable within preexisting pod, cup and panel gauge mounts, thereby allowing a vehicle owner to customize a vehicle for multiple uses. The sound pressure instrument receives a sound pressure wave through a microphone mounted at about the drivers' ear level and processes the resultant electrical signals through a signal processing means into groups of digital pulses. The digital pulses are displayed on an analog and/or digital display in real time. Associated with the signal processing means is a monitoring means which indicates when the received sound pressure waves are above predetermined levels. Associated with both of these means is an peak storage means which monitors each group of digital pulses and also any signals provided by the monitoring means. Utilizing these, the peak storage means stores the highest achieved sound pressure level in each group of digital pulses which may be recalled at a later time.

### FIELD OF THE INVENTION

The present invention is directed toward a gauge-based instrument for use in a motor vehicle, and more specifically, toward a sound pressure instrument which detects and processes sound pressure waves into quantifiable electrical signals and displays the quantified signals in an analog and/or digital and optionally color coded backlit display. The sound pressure instrument is operatively housed in a standard automotive gauge housing which is positionable in currently available cluster, cup or panel type gauge mounts.

### BACKGROUND OF THE INVENTION

An instrument panel provides a variety of functions within a vehicle. Gauges mounted within the panel are the primary interface between the driver and the vehicle. For example, a speedometer indicates the speed of the vehicle, a tachometer shows the speed of the engine, and various other gauges monitor and show engine temperature, fluid levels and various other parameters.

Typically in a vehicle, a factory installed instrument panel is designed to present a particular arrangement, e.g. a cluster of gauge-type instruments in a pre-set design. These instruments generally include sensors positioned at appropriate points within the engine. Each sensor monitors one of numerous parameters and electrically transmits a proportional output to an associated instrument. A needle or pointer is mounted on the rotary output shaft of a gauge motor and assumes different positions based on the control signal received by the instrument. The needle is positioned near a display bearing markings relevant to the condition being measured, and the needle points to various marks as it turns. For example, if the gauge is part of a speedometer, the markings on the gauge display will indicate various rates of speed in miles or kilometers per hour.

An instrument panel also functions as a key component to the interior design of a vehicle. Through the selection of surface material and contour as well as types of displays, backlighting and switches, the instrument panel can change the personality of a vehicle. Vehicle owners often install aftermarket gauges to enhance the attributes of the vehicle, either for actual performance measurement or to “dress-up” the vehicle for competition. Competition has always been popular among car enthusiasts and has included contests of speed, endurance, detailing, etc., each of which require the vehicle to assume a different personality.

One of the most recent competitions available to a car enthusiast involves sound systems. Car owners compete using a car's sound system to see which is the loudest or most accurate in sound reproduction. Many organizations exist that sanction “sound off” events where points and trophies are awarded to those that have superior sound systems. To ensure fair competition, the sanctioning bodies have developed guidelines for judging the sound systems. Generally, special portable microphones and equipment are used for accurate and repeatable sound pressure measurements. To more accurately represent the listening environment within the vehicle, many of these measurements are performed above the dashboard at close to the drivers ear level.

Various examples of prior art teach portable devices for making sound pressure measurements. The primary thrust of most of these instruments is directed to computing timed exposure to damaging industrial sounds. Therefore these devices are generally configured for hand held operation to allow the measurements to be taken in close proximity to a piece of industrial equipment.

U.S. Pat. No. 5,805,457 teaches a computer-implemented system for analyzing background noise in automobiles including a noise spectrum generator that generates an actual or synthetic noise spectrum representative of the noises created by an automobile. U.S. Pat. No. 3,868,857 teaches an audio dosimeter for individual use in determining exposure to sound energy as a function of both frequency and pressure level, with integration over the time of exposure and incorporating storage means preserving a quantitative measure of the exposure. U.S. Pat. No. 4,554,639 teaches an audio dosimeter for use by an individual for measuring exposure to sound which includes a temperature compensation circuit. U.S. Pat. No. 5,072,415 teaches a method and device for measuring noise using a nuisance index. U.S. Pat. No. 2,982,914 teaches a noise meter proposed to include a microphone, amplifiers, a rectifier, an integrator, and an indicator. This teaching is directed to indicating a measurement which is proportional to the hazardous effects of a noisy environment. U.S. Pat. No. 3,802,535 teaches an acoustic noise exposure meter which is proposed to detect sound intensity levels above 90 decibels. The device is proposed to include a receiver, an AC-to-DC converter, a voltage-controlled oscillator, a noise threshold comparator, and a counter for displaying a measurement representing total noise to which a person has been exposed. U.S. Pat. No. 3,747,703 teaches a noise exposure computer and method which are proposed to indicate cumulative noise exposure. This patent indicates the use of operational amplifiers in the circuits of the proposed device. Another patent disclosing the use of operational amplifiers in sound indicators is U.S. Pat. No. 3,545,564. Other noise exposure meter patents known to Applicant are U.S. Pat. No. 3,014,550 and U.S. Pat. No. 3,144,089 which propose the use of electrochemical integrator units in their indicators.

While it is also known in the prior art to configure sound pressure instruments for vehicular use, all known sound pressure instruments constructed specifically for vehicles are configured for in dash or under dash mounting and do not allow measurements to be taken above the dash level. Due to the acoustics within a vehicle, sound pressure measurements taken at or below the dash level do not accurately reflect the sound pressure or sound reproduction above the dash, e.g. at ear level. In addition these instruments are difficult to read while driving and require the driver to divert attention from the road for extended time periods. Because many of the instruments must be read while the vehicle is in motion, instrumentation must be visible to a person operating a vehicle. A driver will generally focus on the road in front of him when driving, and thus the most convenient location for placing competition instrumentation has been directly within the driver's peripheral vision, either on top of the dashboard or on the A-pillar of the vehicle. A vehicle traveling at 60 miles per hour moves 88 feet per second making gauge placement critical to driver safety. Thus a driver takes his eyes off the road for 88 feet every time he looks at an instrument for one second. Gauges mounted under the dash divert the drivers attention for extended periods of time.

Aftermarket gauges for competition uses are preferably mounted in various positions within the passenger compartment of the vehicle within peripheral view of the driver. Often the aftermarket gauges are mounted in groups or clusters within gauge pods on the A-pillar of the vehicle or within gauge cups or panels mounted on top of the dash. The cluster mounts allow the driver to view multiple gauges in a single glance. One common type of gauge, often called a panel meter gauge, is housed in a small cylindrically shaped housing having a lens at one end and lead-in terminals at the other end. The housings are generally available in various standard diameters, with 2 1/16″ and 2⅝″ being the most popular. The standard diameters of the gauge housings correspond to apertures provided in the gauge pods, cups and panels to allow the instrument panels to be customized according to the vehicle owner's preference. Because these gauges are modular and can be used for many purposes, they are produced in high volume and as a result, costs are kept low.

The prior art under dash sound pressure devices for vehicular use require additional mounting hardware which may require professional installers and may reduce leg room available to passengers. In addition, the large square construction of these instruments detract from interior style themes and the overall appearance of the vehicle which is critical for show and sound off competition.

Because of the importance to interior style, a need exists for a variety of universally mountable gauges having a flexible design architecture that readily supports change in configuration to provide a vehicle owner with the ability to create vehicle versatility. More specifically, what is needed is a sound pressure instrument that can be retrofitted into existing pod, cup and panel gauge mount configurations for customization of the vehicle. The sound pressure instrument should be configured for installation into the pre-existing gauge mounts without the need to drill extra holes or assemble additional mounting hardware. The sound pressure instrument should be easily and directly readable at a glance, and should not require any additional references to determine when predetermined levels of sound have been reached. In addition, the sound pressure instrument should not require calibration after installation and should store a peak level of sound pressure each operation cycle of the vehicle which can be recalled at a later time.

### SUMMARY OF THE INVENTION

The present invention overcomes the aforementioned and other shortcomings of the prior art by providing a novel and useful gauge-based sound pressure instrument that is mountable within preexisting pod, cup and panel gauge mounts, thereby allowing a vehicle owner to customize a vehicle for multiple uses.

The sound pressure instrument of the present invention receives a sound pressure wave through a microphone mounted at about the drivers' ear level and processes the resultant electrical signals through a signal processing means into groups of digital pulses. Associated with the signal processing means is a monitoring means which indicates when the received sound pressure waves are above predetermined levels. Associated with both of these means is a peak storage means which monitors each group of digital pulses and also any signals provided by the monitoring means. Utilizing these, the peak storage means stores the highest achieved sound pressure level in each group of digital pulses. Once the peak sound level is stored, the peak sound pressure level is connected to an indicator means which, in a preferred embodiment, can be recalled at any time and visually displayed to indicate the highest achieved sound pressure levels.

In the preferred embodiment of the present invention these appropriately combined signal processing circuits are housed in a small cylindrically shaped housing having a lens at one end and lead-in terminals at the other end. The cylindrical housing is preferably sized for standard diameter pod, cup and panel cluster gauge mounts. The faceplate of the gauge has an associated analog display and a three or four digit digital numeric readout which uses an LED, LCD or electro-luminous display which progressively illuminates elements as the sound pressure level increases. This digital readout is appropriately connected to the signal processing circuit elements so that the first three digits display the sound pressure levels for an accuracy level to 1 db. The last digit of the digital display can be added to display an accuracy to 0.1 db. Also mounted in the housing is a switch which can be externally manipulated for selecting the previously stored peak pressure level as well as resetting the peak level to zero. The backlighting of the gauge, as well as the analog display, may also be configured to change the backlighting color in relation to the sound pressure level. In this configuration, as the sound pressure level increases the backlighting would give the driver an additional visual indication of the sound level without requiring his eyes to be diverted from the road, further increasing the safety aspects of the device.

Accordingly, a primary objective of the instant invention is to teach a gauge-based sound pressure instrument which is mountable within preexisting pod, cup and panel gauge mounts, thereby allowing a vehicle owner to customize a vehicle for multiple uses.

Another objective of the instant invention is to teach a gauge-based sound pressure instrument that is mountable on or above the dash of a vehicle to provide an accurate representation of the listening environment at ear level.

Yet another objective of the instant invention is to teach a gauge-based sound pressure instrument that provides multi-colored backlighting to provide visual sound pressure indicators to the vehicle operator without diverting attention from the road.

Still another objective of the instant invention is to teach a gauge-based sound pressure instrument having a digital and an analog display on the same gauge face.

Still yet another objective of the instant invention is to teach a gauge-based sound pressure instrument that does not require a mental calculation to determine if the sound pressure is at a dangerous level.

Other objectives and advantages of this invention will become apparent from the following description taken in conjunction with the accompanying drawings wherein set forth, by way of illustration and example, certain embodiments of this invention.

The drawings constitute a part of this specification and include exemplary embodiments of the present invention and illustrate various objectives and features thereof.

### BRIEF DESCRIPTION OF THE DRAWINGS

FIG. 1 sets forth a pictorial view of a car instrument panel illustrating the instant invention mounted within a pod mount on the A-pillar and within a cup mount on the top of the dash;

FIG. 2 sets forth a front view of a gauge-based sound pressure instrument illustrating a combination digital and analog display together with a rotatable bezel;

FIG. 3 sets forth a side view of the gauge-based sound pressure instrument of the instant invention;

FIG. 4 sets forth an exemplary illustration of a signal processing means block diagram for a gauge-based sound pressure instrument having a digital display;

FIG. 5 sets forth an exemplary illustration of a signal processing means block diagram for a gauge-based sound pressure instrument having an analog display;

FIG. 6 sets forth an exploded view, illustrating the instant invention in cooperation with an A-pillar mountable gauge pod;

FIG. 7 sets forth an exploded view, illustrating the instant invention in cooperation with an on top of the dash mountable gauge panel, and

FIG. 8 sets forth an exploded view, illustrating the instant invention in cooperation with an on top of the dash mountable gauge cup.

### DETAILED DESCRIPTION OF THE PREFERRED EMBODIMENT

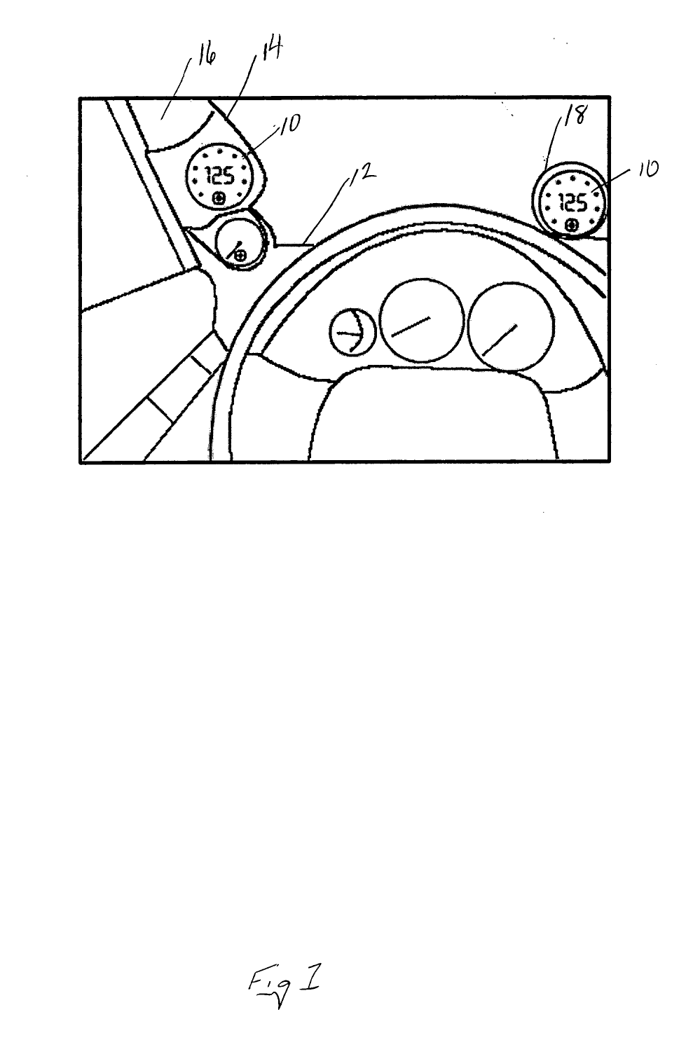

FIG. 1 sets forth a pictorial view of a vehicular dash panel 12 illustrating the instant invention gauge-type sound pressure instrument 10 mounted within a pod mount 14 on the A-pillar 16 and also within a cup gauge mount 18 on the top of the dash panel.

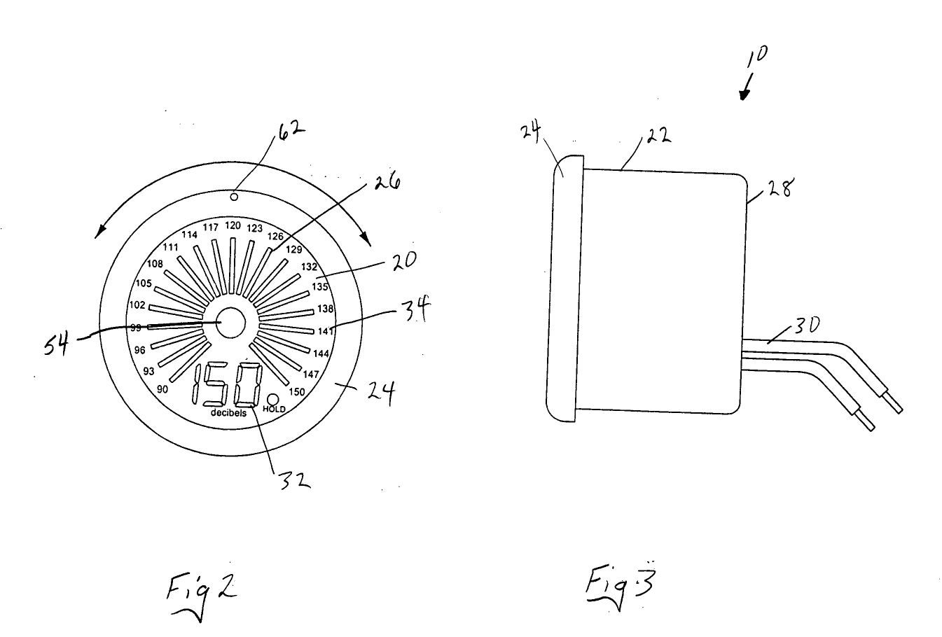

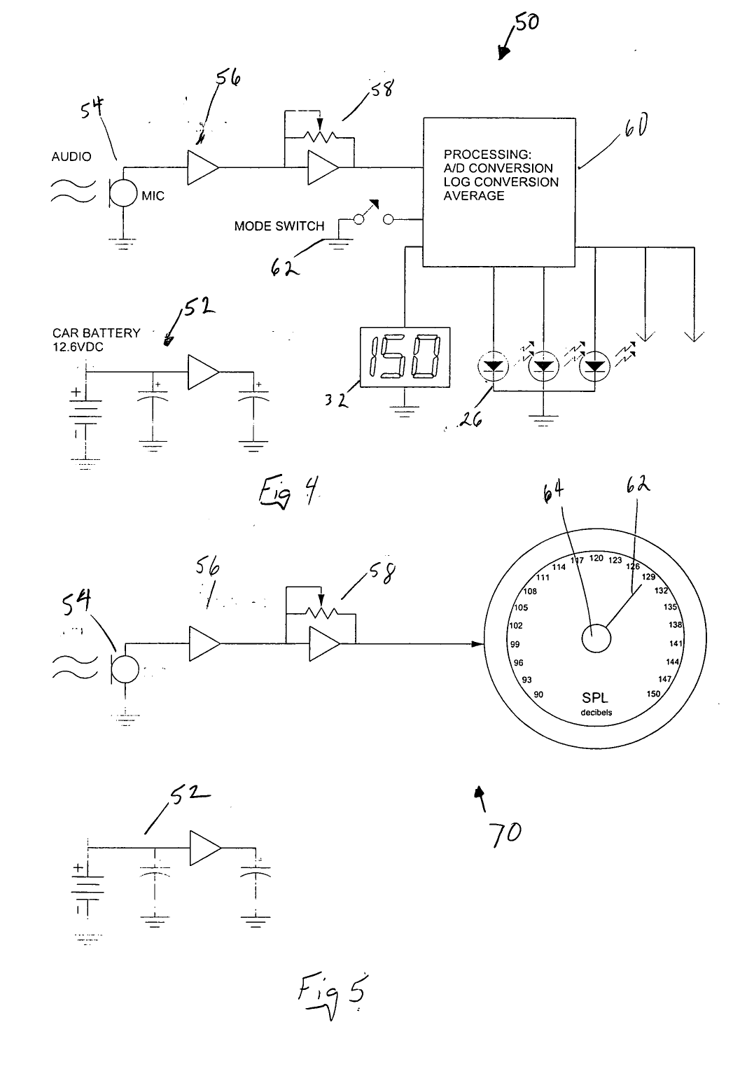

Referring to FIGS. 2 and 3, the overall assembled layout of the gauge-type sound pressure instrument is shown. The instrument generally includes a faceplate 20, a cylindrically shaped housing 22, a bezel 24, a crystal (not shown) and a signal processing means 50 (FIGS. 3 and 4). The faceplate 20 comprises a generally circular sheet of material having indicia 34 imprinted on one side. The indicia 34 is preferably sized, colored and arranged around the perimeter of the faceplate for easy viewing to the vehicle driver. The faceplate may also include visual sound level indicators 26 in the form of LED, LCD or Electro-Luminous displays and the like. The visual sound level indicators in the preferred embodiment are constructed and arranged to change in color as the sound pressure level increases. The faceplate may also include a digital display 32 appropriately connected to the signal processing circuit so that the first three digits display the sound pressure levels for an accuracy level to 1 db. The digital display may also include a fourth digit which can be added to display an accuracy to 0.1 db. Also mounted in the cylindrical housing 22 is a switch 62 (FIG. 4) which can be externally manipulated for selecting the previously stored peak pressure level, as well as resetting the peak level to zero. In the preferred embodiment, the switch 62 is operated by rotating the bezel 24 in a first direction to recall the peak recorded value; rotation in a second direction resets the peak value to zero. Alternative embodiments may include touch screens or other contact type switches which are well known in the art. The bezel is also constructed and arranged to secure the crystal. The crystal is a clear material such as polycarbonate suitable for through viewing. Of course, other clear solid or laminated plastics or glass may be used as the crystal. The housing 22 is generally cylindrical in shape and may be made from metal, plastic or suitable combinations thereof by methods well known in the art. The diameter of the cylindrical housing is preferably sized to fit standard vehicular gauge mounts. Two popular diameters for gauges are 2 1/16″ and 2⅝″. The back portion 28 of the cylindrical housing 22 is preferably constructed and arranged with at least one aperture (not shown) for wire leads 30. The back portion of the cylindrical housing may also include two outwardly extending studs (not shown) or other mounting means well known in the art for mounting the sound pressure instrument within a pod, cup or panel type mount.

Referring to FIG. 4, a block diagram 50 illustrating a means for processing sound pressure levels measured within a vehicle for display upon a digital gauge faceplate is shown. The signal processing circuit is preferably in electric communication with the vehicle's battery (not shown) via a voltage regulator 52. Voltage regulators of this type are well known in the art and therefore a detailed description will be omitted. Alternatively, the signal processing means may include a battery(s) suitable for supplying electrical power to the signal processing circuit 50. The signal processing circuit receives signals from a microphone 54. The microphone 54 is of a type well known in the art and is preferably secured within the faceplate 20 of the sound pressure instrument. Alternatively, the microphone may be remotely mounted and connected to the instrument via wires. The microphone 54 is in electrical communication with a buffer/weighting filter 56 which is in communication with a conditioning/gain circuit 58. The condition/gain circuit is in electrical communication with the processing circuit 60 which converts the signal to digital for calculating and displaying sound pressure level on the faceplate displays 32 and 26.

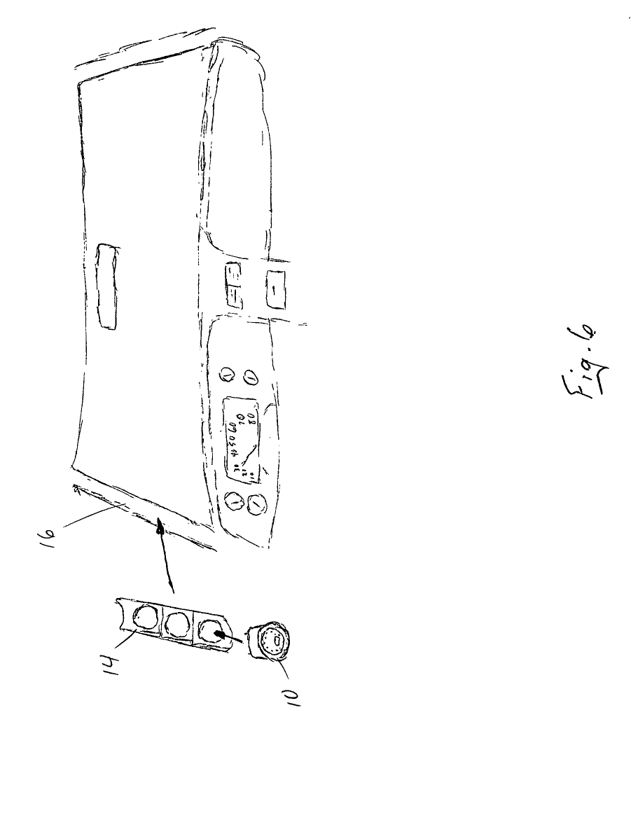

Referring to FIG. 5, a block diagram 70 illustrating a means for processing sound pressure levels measured within a vehicle for display upon an analog gauge faceplate is shown. The signal processing circuit is preferably in electric communication with the vehicle's battery (not shown) via a voltage regulator 52. Voltage regulators of this type are well known in the art and therefore a detailed description will be omitted. Alternatively the signal processing means may include a battery(s) suitable for supplying electrical power to the signal processing circuit 70. The signal processing circuit receives signals from a microphone 54. The microphone 54 is of a type well known in the art and is preferably secured within the faceplate 20 of the sound pressure level instrument. Alternatively, the microphone may be remotely mounted and connected to the instrument via wires. The microphone is in electrical communication with a buffer/weighting filter 56 which is in communication with a conditioning/gain circuit 58. The conditioning/gain circuit 58 controls movement of the indicating pointer 62 fixed to armature 64 by means well known in the art for controlling analog panel meter gauges.

In alternate embodiments the processing means for the digital or analog circuits may include a branch circuit (not shown) connected to the processing circuit for controlling the backlighting of the gauge so that the gauge gives color coded indications to indicate various sound pressure levels. The branch circuit includes a plurality of indicating lamps connected to the branch circuit so that different lamps illuminate when the sound pressure exceeds the threshold values. In operation, the gauge gives a first backlighting indication, e.g. green, when the sound pressure level is at or below a first threshold value and gives a second backlighting indication, e.g. yellow, when the sound pressure level is below a second threshold value and a third backlighting indication, e.g. red, when the sound pressure level has exceeded the second threshold value. In this manner the driver is given a visual indicator that can be interpreted without looking directly at the gauge.

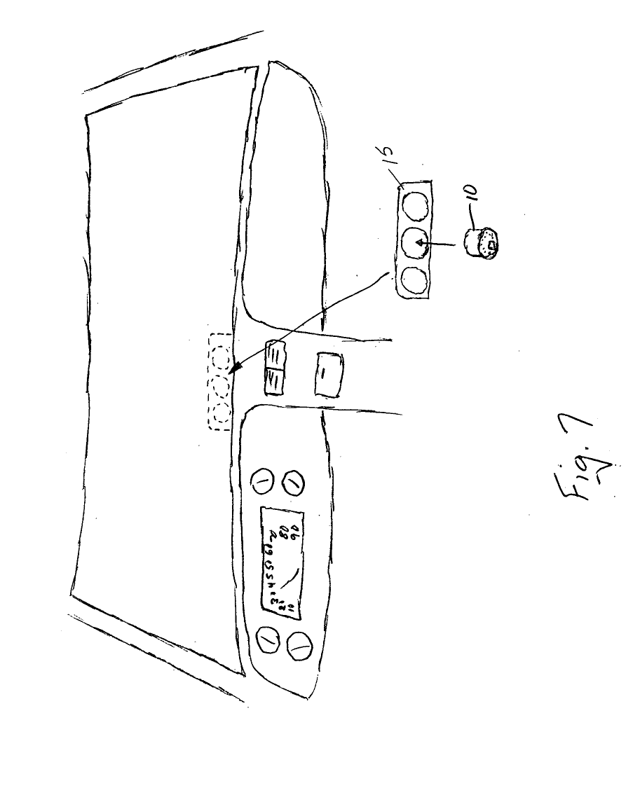

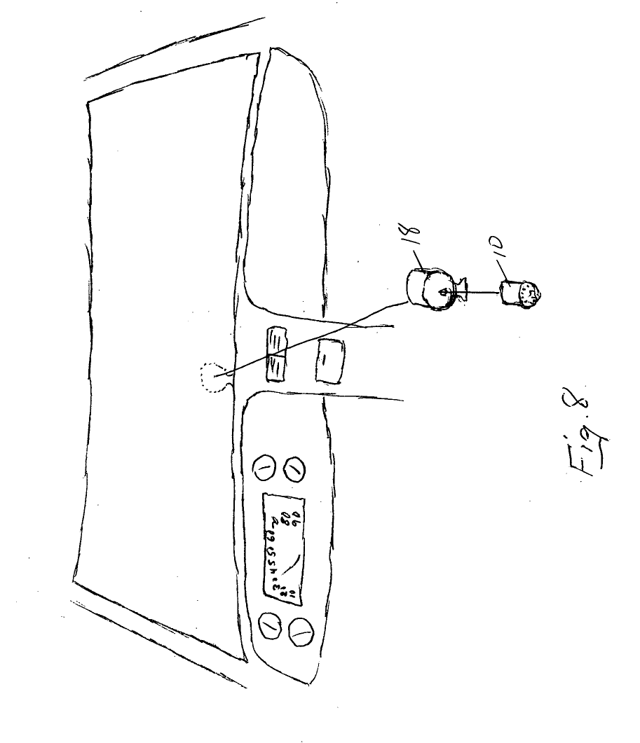

Referring to FIGS. 6 through 8, an exploded view of the sound pressure instrument 10 cooperating with an A-pillar mountable pod type gauge mount 14 (FIG. 6), a dash mountable panel type gauge mount 15, and a dash mountable cup type gauge mount 18 are illustrated. It should be appreciated that the construction of the cylindrical housing 22 is adapted to create a flexible design architecture that readily supports change in configuration to provide a vehicle owner with the ability to create vehicle versatility. It should also be appreciated that the construction of the sound pressure instrument 10 permits the instrument to be mounted at about the drivers' ear level, for accurate sound pressure measurement and ease of viewing.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, and are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. An gauge-based instrument for measuring the sound pressure within a vehicle comprising:
a cylindrical gauge housing, said cylindrical gauge housing having a front portion, a rear portion and a diameter, said front portion constructed and arranged for securement of a faceplate;
a faceplate, said faceplate having sound pressure level markings thereon, said markings being visible through said front portion of said housing;
a gauge motor disposed adjacent to said faceplate;
a signal processing means for receiving a signal indicative of the sound pressure level within said vehicle, said circuit controlling said gauge motor based on said signal;
a pointer extending out of said gauge motor and movable by said gauge motor;
wherein said sound pressure level gauge is mountable within a standard gauge mount.

2. A vehicular sound pressure instrument as set forth in claim 1 including a pointer light source to emit light through said pointer as said pointer is pivoted by said gauge motor.

3. A vehicular sound pressure instrument as set forth in claim 2 wherein said light source is chosen from a group consisting of light bulbs, Light Emitting Diodes and Electro-luminescence, wherein said light source emits light of a different wavelength such that said light source can be used to identify different sound level conditions.

4. A vehicular sound pressure instrument as set forth in claim 1 wherein said signal processing means is adapted to store a peak sound pressure level during operation of said vehicle;
wherein said peak sound pressure may be recalled and displayed on said faceplate during and after operation of said vehicle.

5. A vehicular sound pressure instrument as set forth in claim 4 wherein said front portion of said cylindrical gauge housing is constructed and arranged to include a rotating bezel, said rotating bezel having a larger diameter than said cylindrical housing diameter;
wherein rotation of said bezel in a first direction recalls said peak sound pressure level and rotation of said bezel in a second direction resets said peak sound pressure to zero.

6. A vehicular sound pressure instrument as set forth in claim 4 wherein said faceplate is constructed and arranged to include at least one switch;
wherein operation of said at least one switch in a first mode recalls said peak sound pressure level and operation of said at least switch in a second mode resets said peak sound pressure to zero.

7. A vehicular sound pressure instrument as set forth in claim 1 wherein said faceplate markings indicate decibels.

8. A vehicular sound pressure instrument as set forth in claim 1 wherein said faceplate includes a digital display for digitally indicating said sound pressure level within said vehicle.

9. A vehicular sound pressure instrument as set forth in claim 5 wherein said rotating bezel includes a rubber cover for isolating said vehicular sound pressure instrument from unwanted vibration and aesthetically enhancing said rotating bezel.

10. A vehicular sound pressure instrument as set forth in claim 1 wherein said cylindrical housing is constructed and arranged for mounting in a pod type gauge cluster mount;
wherein said pod type gauge cluster mount is adapted to mount on the A-pillar of said vehicle.

11. A vehicular sound pressure instrument as set forth in claim 1 wherein said cylindrical housing is constructed and arranged for mounting in a cup type gauge mount;
wherein said cup type gauge mount is adapted to mount on the dash of said vehicle.

12. A vehicular sound pressure instrument as set forth in claim 1 wherein said cylindrical housing is constructed and arranged for mounting in a panel type gauge cluster mount;
wherein said panel type gauge cluster mount is adapted to mount on the dash of said vehicle.

13. A vehicular sound pressure instrument as set forth in claim 1 wherein said circuit means includes at least one microphone, said microphone being positioned at about ear level within said vehicle, said microphone constructed and arranged for electrical communication with said signal processing means.

14. A vehicular sound pressure instrument as set forth in claim 13 wherein said faceplate is adapted to secure said microphone.

15. A vehicular sound pressure instrument as set forth in claim 1 wherein said sound pressure level instrument includes a backlighting source, said backlighting source emitting light such that said light is reflected within said cylindrical housing and refracted out of said front portion of said cylindrical housing.

16. A vehicular sound pressure instrument as set forth in claim 15 wherein said backlighting source is chosen from a group consisting of light bulbs, Light Emitting Diodes and Electro-luminescence, wherein said backlighting source emits light of a different wavelength such that said backlighting source can be used to identify different sound pressure levels.

17. A vehicular sound pressure instrument as set forth in claim 1 wherein said cylindrical housing diameter is about two and one-sixteenth inches.

18. A vehicular sound pressure instrument as set forth in claim 1 wherein said cylindrical housing diameter is about two and five-eighths inches.

19. An instrument for measuring the sound pressure level within a vehicle comprising:
a cylindrical gauge housing, said cylindrical gauge housing having a front portion, a rear portion and a diameter, said front portion constructed and arranged for securement of a faceplate;
a faceplate, said faceplate having sound pressure level markings thereon, said faceplate adapted to secure a plurality of light emitting diodes positioned with respect to said sound pressure level markings, said markings and said light emitting diodes being visible through said front portion of said housing;
a signal processing means for receiving a signal indicative of the sound pressure level within said vehicle, said signal processing means controlling operation of said plurality of light emitting diodes based on said signal;
wherein said sound pressure instrumemnt is mountable within a standard gauge mount.

20. A vehicular sound pressure instrument as set forth in claim 19 wherein said circuit means is adapted to store a peak sound pressure level during operation of said vehicle;
wherein said peak sound pressure level may be recalled and displayed on said faceplate during and after operation of said vehicle.

21. A vehicular sound pressure instrument as set forth in claim 20 wherein said front portion of said cylindrical gauge housing is constructed and arranged to include a rotating bezel, said rotating bezel having a larger diameter than said cylindrical housing diameter;
wherein rotation of said bezel in a first direction recalls said peak sound pressure level and rotation of said bezel in a second direction resets said peak sound pressure to zero.

22. A vehicular sound pressure instrument as set forth in claim 20 wherein said faceplate is constructed and arranged to include at least one switch;
wherein operation of said at least one switch in a first mode recalls said peak sound pressure level and operation of said at least one switch in a second mode resets said peak sound pressure to zero.

23. A vehicular sound pressure instrument as set forth in claim 19 wherein said faceplate markings indicate decibels and said light emitting diodes are progressively activated with respect to sound pressure levels within said vehicle.

24. A vehicular sound pressure instrument as set forth in claim 19 wherein said faceplate includes a digital display for digitally indicating said sound pressure level within said vehicle.

25. A vehicular sound pressure instrument as set forth in claim 21 wherein said rotating bezel includes a rubber cover for isolating said sound pressure instrument from unwanted vibration and aesthetically enhancing said rotating bezel.

26. A vehicular sound pressure instrument as set forth in claim 19 wherein said cylindrical housing is constructed and arranged for mounting in a pod type gauge cluster mount;
wherein said pod type gauge cluster mount is adapted to mount on the A-pillar of said vehicle.

27. A vehicular sound pressure instrument as set forth in claim 19 wherein said cylindrical housing is constructed and arranged for mounting in a cup type gauge mount;
wherein said cup type gauge mount is adapted to mount on the dash of said vehicle.

28. A vehicular sound pressure instrument as set forth in claim 19 wherein said cylindrical housing is constructed and arranged for mounting in a panel type gauge cluster mount;
wherein said panel type gauge cluster mount is adapted to mount on the dash of said vehicle.

29. A vehicular sound pressure instrument as set forth in claim 19 wherein said circuit means includes at least one microphone, said microphone being positioned at about ear level within said vehicle, said microphone constructed and arranged for electrical communication with said circuit means.

30. A vehicular sound pressure instrument as set forth in claim 29 wherein said faceplate is adapted to secure said microphone.

31. A vehicular sound pressure instrument as set forth in claim 19 wherein said sound pressure level instrument includes a backlighting source, said backlighting source emitting light such that said light is reflected within said cylindrical housing and refracted out of said front portion of said cylindrical housing.

32. A vehicular sound pressure instrument as set forth in claim 31 wherein said backlighting source includes a plurality of light bulbs wherein each of said plurality of light bulbs emits light of a different wavelength such that each of said plurality of light bulbs can be used for different sound pressure levels to identify said different sound pressure levels.

33. A vehicular sound pressure instrument as set forth in claim 19 wherein said cylindrical housing diameter is about two and one-sixteenth inches.

34. A vehicular sound pressure instrument as set forth in claim 19 wherein said cylindrical housing diameter is about two and five-eighths inches.
